(19) United States
(12) Patent Application Publication
(10) Pub. No.: US 2017/0043426 A1
(43) Pub. Date: Feb. 16, 2017

(54) TITANIUM CARBIDE OVERLAY AND METHOD OF MAKING

(71) Applicant: OERLIKON METCO (US) INC., Westbury, NY (US)

(72) Inventors: Petr FIALA, Fort Saskatchewan, Alberta (CA); Othelo Enojo CHAVES, Edmonton, Alberta (CA); Eric KOZCULAB, Sherwood Park, Alberta (CA)

(73) Assignee: OERLIKON METCO (US) INC., Westbury, NY (US)

(21) Appl. No.: 15/305,829

(22) PCT Filed: Apr. 9, 2015
(86) PCT No.: PCT/US15/25055

§ 371 Date: Oct. 21, 2016

Related U.S. Application Data
(60) Provisional application No. 61/986,516, filed on Apr. 30, 2014.

(51) Int. Cl. B23K 10/02; C22C 19/05; B22F 1/02; C22C 38/34; C22C 38/00; B22F 1/00; C22C 38/40

(52) U.S. Cl. CPC B23K 10/027; B22F 1/0014; C22C 19/055; C22C 38/40; C22C 38/34; C22C 38/005; C22C 38/002; B22F 1/025; B23K 2203/18

(57) ABSTRACT

Compositions and methods for applying to a surface an overlay comprising titanium carbide are provided. The compositions include rounded titanium carbide particles and optionally include angular titanium carbide particles. The compositions may be applied, for example, by plasma transferred arc or spray/fuse deposition.

### CROSS-REFERENCE TO RELATED APPLICATIONS

The instant application is an International Application claiming priority of U.S. Provisional Application No. 61/986,516, filed Apr. 30, 2014, the disclosure of which is hereby expressly incorporated by reference herein in its entirety.

### FIELD OF THE INVENTION

The invention relates to compositions and methods for applying to a surface an overlay comprising titanium carbide.

### BACKGROUND OF THE INVENTION

Several different methods are known for manufacturing a metallic overlay on a substrate, including plasma transferred arc welding (PTA), spray-and-fuse methods, gas tungsten arc welding, gas metal arc welding, and laser cladding. PTA can be used to fuse a metallic coating to a substrate in order to improve its resistance against wear and/or corrosion, a technique also called hardfacing.

In the PTA process, a non-transferred arc is formed between an electrode and the nozzle, and then a transferred arc is formed between the electrode and the workpiece. When the transferred arc is ignited, the workpiece becomes part of the electrical circuit and the plasma arc is directed and focused through the torch orifice onto the workpiece. A powder composition (comprising, e.g., alloys and or carbides) is metered into the nozzle, under a positive pressure gas flow, and onto the workpiece surface, thereby forming a molten deposit that hardens as it cools. By moving the torch and/or workpiece, a weld overlay deposit can be formed on the workpiece.

Titanium carbide (TiC) is material with a high degree of hardness, and so it would be desirable to use TiC in a PTA process. However, TiC is also a very low density material compared to most metals. Therefore, when used in a PTA process, commercially available TiC particles tend to float to the top of the deposit before the deposit cools and hardens. This results in an uneven deposit where TiC is mostly in the top portion, with relatively little in the intermediate portion and adjacent to the workpiece. This effect is exacerbated when thick deposit layers are required, and in multi-pass deposition processes. As a result, TiC for hardfacing is mostly used in fine granular or agglomerated and sintered forms, and generally applied by methods other than PTA or spray/fuse deposition.

U.S. Pat. No. 4,615,734, which is incorporated by reference herein in its entirety, comments on the disadvantageous tendency of TiC to float in PTA applications. The document discloses a composition comprising 30-50 wt % angular TiC, 10-30% chromium, about 1.5-5% carbon, and the balance essentially iron. The powder is sintered then consolidated onto a surface by hot isostatic pressing.

U.S. Pat. No. 3,725,016, which is incorporated by reference herein in its entirety, forms a hard surface with a composition comprising 10-75% fine TiC powder (e.g., 5-7 μm), 25-90% steel-forming matrix, and other optional components; forming the composition into a slurry; and applying the slurry to a metal substrate by spraying, dipping, or painting; followed by drying.

There remains a need for a method to apply a TiC coating on a substrate by a welding method, such as PTA and spray/fuse deposition. The method is preferably amenable for use with coarse TiC, e.g., particles larger than 45 μm.

There remains a need for uniform substrate hardface coatings comprising TiC, preferably coarse TiC, that can be applied by a welding method such as PTA and spray/fuse deposition.

### SUMMARY OF THE INVENTION

It has surprisingly been found that the floating behavior of TiC, as well as weldability problems, porosity, and process instability, are affected by the morphology, size, and particle density, of the TiC particles. It has been surprisingly found that controlling the morphology and size of the TiC particles permits its use in PTA and spray/fuse deposition processes, and provides a substrate coating having improved homogeneity.

The present invention provides a method of preparing an overlay on a substrate, the overlay comprising titanium carbide, the method comprising: (a) obtaining a composition comprising TiC particles and non-TiC particles; and (b) applying the composition to a substrate with plasma transferred arc or spray/fuse deposition to form an overlay; wherein the TiC particles are −60+325 mesh size; wherein the titanium carbide particles comprise 50-100% by weight rounded particles, and 0-50% by weight angular particles, based on weight of TiC; and wherein the TiC comprises 5-70 wt % of the composition, based on weight of TiC and non-TiC particles; wherein the non-TiC particles comprise an alloy and/or a nonmetal.

The present invention also provides a composition suitable for plasma transferred arc welding or spray/fuse deposition, the composition comprising TiC particles and non-TiC particles, wherein the TiC particles are −60+325 mesh size; wherein the titanium carbide particles comprise 50-100% by weight rounded particles, and 0-50% by weight angular particles, based on weight of TiC; and wherein the TiC comprises 5-70 wt % of the composition, based on weight of TiC and non-TiC particles; wherein the non-TiC particles comprise an alloy and/or a nonmetal.

The present invention also provides an overlay comprising titanium carbide particles, wherein the overlay is prepared by (a) obtaining a composition comprising TiC particles and non-TiC particles; and (b) applying the composition to a substrate by plasma transferred arc welding or spray/fuse deposition to form an overlay; wherein the TiC particles are −60+325 mesh size; wherein the titanium carbide particles comprise 50-100% by weight rounded particles, and 0-50% by weight angular particles, based on weight of TiC; and wherein the TiC comprises 5-70 wt % of the composition, based on weight of TiC and non-TiC particles; wherein the non-TiC particles comprise an alloy and/or a nonmetal.

The present invention also provides an overlay comprising titanium carbide particles, wherein the overlay is prepared by applying a composition comprising TiC particles to a substrate by plasma transferred arc welding or spray/fuse deposition to form the overlay on the substrate, wherein the overlay comprises TiC particles of −60+325 mesh size, wherein the TiC particles are homogeneously distributed in the overlay. Preferably, the titanium carbide particles in the composition comprise 50-100% by weight rounded particles, and 0-50% by weight angular particles, based on weight of TiC.

The present invention also provides a composition suitable for plasma transferred arc welding or spray/fuse deposition, the composition comprising clad TiC particles, wherein the clad TiC particles are −60+325 mesh size; wherein the clad TiC particles comprise titanium carbide particles and a cladding material; wherein the titanium carbide particles comprise 50-100% by weight rounded particles, and 0-50% by weight angular particles, based on weight of TiC; wherein the clad TiC particles comprise 5-70 wt % TiC; and wherein the cladding material comprises a metal and/or an alloy.

The present invention also provides a method of preparing an overlay on a substrate, the overlay comprising titanium carbide, the method comprising:
(a) obtaining a composition according to claim 13; and
(b) applying the composition to a substrate by plasma transferred arc welding or spray/fuse deposition to form an overlay.

The present invention also provides an overlay comprising titanium carbide particles, wherein the overlay is prepared by:
(a) obtaining a composition according to claim 13; and
(b) applying the composition to a substrate by plasma transferred arc welding or spray/fuse deposition to form an overlay.

The present invention also provides an overlay comprising titanium carbide particles, wherein the overlay is prepared by applying the composition of claim 13 to a substrate by plasma transferred arc welding or spray/fuse deposition to form the overlay on the substrate, wherein the overlay comprises TiC particles of −60+325 mesh size, and wherein the TiC particles are homogeneously distributed in the overlay.

The composition preferably comprises densified TiC particles, more preferably plasma-densified TiC particles. Preferably, the TiC particles are of −100+230 mesh size. Preferably, the composition is of −60+325 mesh size, more preferably of −100+230 mesh size.

Preferably, the non-TiC particles comprise an alloy comprising nickel or iron. Preferably, the non-TiC particles comprise a non-metal.

Cladding material preferably includes nickel metal or an alloy comprising nickel. Preferred nickel alloy cladding materials include chromium and/or aluminum.

Preferably, the applying comprises plasma transferred arc welding. Preferably, the overlay comprises homogeneously distributed TiC.

### BRIEF DESCRIPTION OF THE DRAWINGS

FIG. 1 is an SEM photomicrograph, magnification 200×, of a TiC powder useful in the current invention. The reference line is 100 μm.

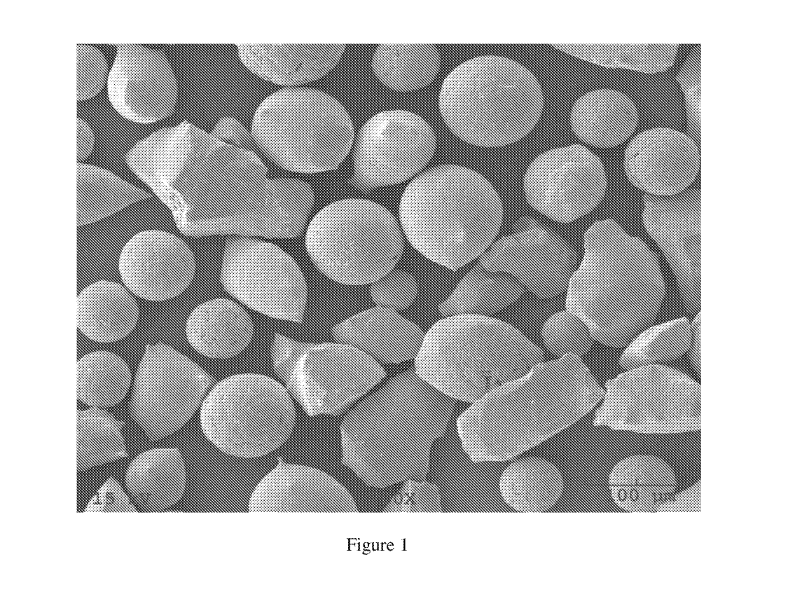

FIG. 2 is an OLM photomicrograph, magnification 15×, of a material comprising 32 wt % TiC and 68 wt % Ni self fluxing alloy. The reference line is 1000 μm.

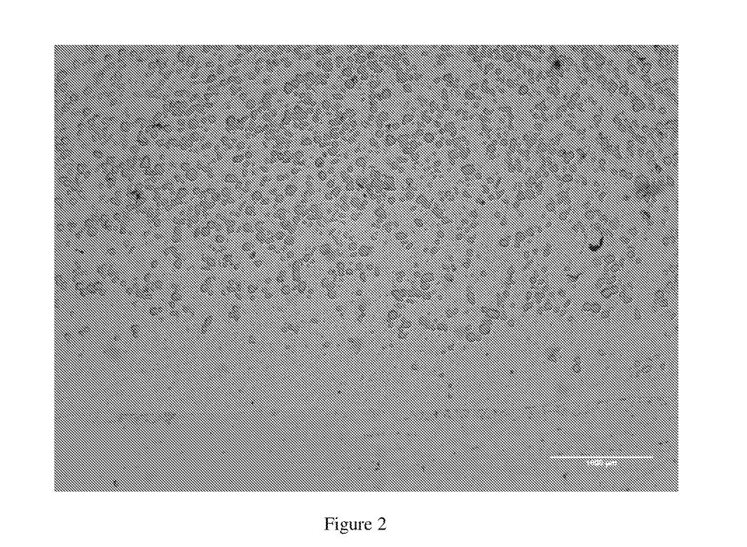

FIG. 3 is a photograph of a cross-section of an overlay comprising TiC particles, deposited according to Example 1.

FIG. 4 is a photograph of a cross-section of an overlay comprising TiC particles, deposited according to Example 2.

FIG. 5 is a photograph of a cross-section of an overlay comprising TiC particles and alloy (30/70 weight ratio), deposited according to Example 3.

FIG. 6 is a photograph of a cross-section of an overlay comprising TiC particles and alloy (50/50 weight ratio), deposited according to Example 3.

FIG. 7 is a photograph of a cross-section of an overlay comprising TiC particles and alloy (70/30 weight ratio), deposited according to Example 3.

FIG. 8 is a photograph of a cross-section of an overlay comprising nickel-clad TiC particles deposited according to Example 4.

FIG. 9 is a photograph of a cross-section of an overlay comprising alloy-clad TiC particles deposited according to Example 5.

FIG. 10 is a photograph of a cross-section of an overlay comprising alloy-clad TiC particles deposited according to Example 6.

### DETAILED DESCRIPTION OF THE INVENTION

It has been surprisingly found that the floating tendency of titanium carbide can be controlled by controlling the density and morphology of the titanium carbide particles. Rounded (smooth) densified particles of titanium carbide tend to sink in a freshly deposited (non-solidified) layer. On the other hand, it appears that angular particles of densified titanium carbide tend either to float, or to sink slowly enough to set in place as the overlay hardens. It has been unexpectedly found that by using a combination of rounded and angular particles, it is possible to balance these tendencies against each other, thereby obtaining a substantially more uniform distribution of TiC particles, preferably coarse TiC particles, in a hardcoat than previously possible.

The present invention provides a method of coating a substrate with a powder composition comprising titanium carbide. The titanium carbide preferably comprises particles that are rounded, and more preferably also comprises particles that are angular. In addition to titanium carbide, the composition may comprise other components, such as metals, alloys, non-metal, and/or other carbides. The coating method is preferably gas plasma (e.g., plasma transferred arc) or spray/fuse deposition.

TiC is readily commercially available in small particle sizes of several micrometers. Such particles can be agglomerated, for example, by preparing a slurry of TiC particles and an organic binder, injecting the slurry into a spray dryer chamber, and atomizing with a compressed gas. Spherical agglomerates of TiC particles glued together by the binder are collected and may be sintered to remove the binder and increase strength of the agglomerates. Other methods of agglomerating and sintering, or variations of the method described above, are available, including methods known to those having ordinary skill in the art.

While sintering increases strength of TiC agglomerates, the sintered product tends to be porous, which can lead to sintered agglomerate floating in the melt pool. Therefore, the agglomerates are preferably processed to remove pores, thereby making the particles denser. Any method of densification may be used. A preferred method comprises plasma densification. In plasma densification, the agglomerates are injected into an induction plasma where they melt, or partially melt, and then re-solidify into a mix of particles ranging from completely dense and spherical particles to partially melted or un-melted particles with spherical or angular morphology. Induction plasma densification can be carried out, for example, using equipment produced by Tekna Advanced Materials Ltd. It is believed that similar results can be achieved by other methods of densification, for example by methods for making spherical cast tungsten carbide, including methods used routinely by those of ordinary skill in the art. Suitable commercially available products comprising dense rounded particles include TEKMAT TIC-150 and TIC-125 (Tekna Advanced Materials).

Dense TiC particles have a number of other unexpected advantages in addition to reduced floating. The advantages are especially pronounced in PTA or spray/fuse deposition. Dense TiC particles have better particle mechanical properties such as cohesive strength that results in better wear resistance of the hardface. The higher density results in a smaller density difference between TiC and matrix alloy (for example density of Ni alloys are generally about 8-9 g/cm³ depending on alloying elements). The more regular particle shape results in lower drag force and as a result better particle size distribution in an overlay. Dense TiC particles in the sizes discussed below (e.g., at least 45 μm) are especially preferred for their advantageous hardness attributes. The theoretical bulk density of TiC is 4.93 g/cm³. Dense TiC particles in compositions and methods of the present invention preferably have bulk density (including any remaining pores) at least 4 g/cm³, 4.2 g/cm³, 4.4 g/cm³, 4.6 g/cm³, 4.8 g/cm³, or 4.9 g/cm³.

Any source of angular particles of titanium carbide is acceptable. One way of making angular TiC particles is disclosed in U.S. Pat. No. 4,615,734. Angular particles can also be made and/or densified using a plasma torch, such as can be obtained from Tekna Plasma Systems, Inc., preferably densified in an inert atmosphere. Angular particles can also be made by other methods, such as by crushing larger TiC particles.

The ratio of rounded to angular TiC particles can vary according to the requirements of any particular application, and can be determined by one of ordinary skill in the art. As a general matter, the ratio of rounded to angular TiC may be 100:0, 95:5, 75:25, or 50:50, all ratios being by weight. Ranges formed by any combination of these values are also preferred. Suitable commercially available products include TEKMAT TIC-150 and TIC-125 (Tekna Advanced Materials).

Any TiC particle size can be used. However, if the particles of TiC are too small, this can lead to feeding problems during hardcoat application. Smaller particles may also not provide sufficient wear resistance. On the other hand, particles that are too large may not process properly through a plasma gun. The TiC particles are preferably of suitable size to be capable of application using a PTA or a spray/fuse method. The particles are preferably larger than or about 38 μm, 45 μm, 54 μm, or 64 μm. The particles are preferably smaller than or about 250 μm, 210 μm, 177 μm, 149 μm, 125 μm, 105 μm, 88 μm, or 74 μm. All ranges formed from these values are also preferred, e.g., 44-63 μm, 37-88 μm, etc.

When a TiC particle composition comprises particles wholly or partially outside a desired size range, the composition can be modified to attain the target size range. Any of several sizing methods can be used to obtain the target size range, and can be determined by one of ordinary skill in the art. Some sizing methods can also be used to confirm particle size distribution.

A preferred method comprises using meshes, which can be standardized or non-standardized meshes. Standardized meshes are preferred, and are well known to those of ordinary skill in the art. For example, a 325 mesh allows passage of 44 μm particles, and a 270 mesh allows passage of 53 μm particles. Thus, a −270+325 mesh composition comprises particles in the range of 45-53 μm. Some standardized mesh sizes include 60 (250 μm), 70 (210 μm), 80 (177 μm), 100 (149 μm), 120 (125 μm), 140 (105 μm), 170 (88 μm), 200 (74 μm), 230 (63 μm), 270 (53 μm), 325 (44 μm), and 400 (37 μm). All particle size ranges formed by combinations of mesh sizes, preferably standardized mesh sizes, are suitable. Mesh sizes may be used in a descriptive sense, i.e., without regard to how the particle size distribution of a composition was actually obtained. For example, a particle size distribution of 47-52 μm obtained by any method would satisfy a −270+325 distribution and a −230+325 distribution. Some preferred mesh sizes and/or particle sizes for the present invention include −60+325, more preferably −80+270, yet more preferably −100+230.

Any combination of size range of rounded TiC particles and angular TiC particles may be used. It is preferred that both rounded and angular TiC particles meet the same size range.

In addition to TiC, the powder composition can comprise one or more non-TiC component, i.e., components other than TiC, such as metals, alloys, or non-metals, e.g., as a separate powder, or as a cladding material for TiC particles. Any proportion of these components may be used, and can be determined by one of ordinary skill in the art for a particular application, using this disclosure as a guide. Preferably, the TiC comprises at least 5%, 10%, 15%, 20%, or 25% of the powder composition by weight. Preferably, the TiC comprises up to 70%, 60%, 50%, 40% or 30% of the powder composition by weight.

Metals and/or alloys may also be included in the powder composition, e.g., as a separate powder, or as a cladding material for TiC particles. Some preferred metals include iron, nickel, cobalt, copper, and/or aluminum. Some preferred alloys include alloys of iron, nickel, cobalt, copper, and/or aluminum; more preferably alloys of iron, nickel and/or cobalt; yet more preferably alloys of nickel and/or iron. If iron, nickel, cobalt or copper are alloying elements, their content is preferably up to 50 wt % and/or at least 5 wt %, 10 wt %, or 15 wt % of the alloy. Chromium may also optionally be used, and when used, preferably comprises up to 50 wt %, 40 wt %, or 30 wt % of the alloy, and/or at least 5 wt %, 10 wt %, or 15 wt % of the alloy. Aluminum may optionally be used, and when used, preferably comprises up to 20 wt % of the alloy. Other metals that can be included in the alloys include molybdenum, niobium, vanadium, manganese, and/or titanium, each up to 10 wt % of the alloy.

The alloys may comprise non-metallic components as well. For example, the alloys may comprise carbon (preferably less than 1 wt %), silicon (preferably less than 10 wt %, more preferably less than 5 wt %), boron (preferably less than 10 wt %, more preferably less than 5 wt %), and/or phosphorous (preferably less than 10 wt %, more preferably less than 5 wt %).

The particular alloy used depends on the application, and can be determined by one of skill in the art. Nickel-chromium alloys, stainless steel, and carbon steel are preferred. Some preferred nickel-chromium alloys include commercially available powders such as METCOCLAD, AMDRY, and METCO (all available from Oerlikon Metco). Some suitable stainless steels include the 300 Series (austenitic chromium-nickel steels) such as Type 304 and Type 316; and the 400 Series (ferritic and martensitic chromium steels) such as Type 410, Type 420, and Type 430. Some suitable carbon steels include low-carbon steel with up to 0.3% C (such as AISI 1008, 1010, 1015, 1018, 1020, 1022, 1025), medium carbon steel with 0.3-0.6% C (such as AISI 1030, 1040, 1050, 1060); and high carbon steel with 0.6-0.95% C (such as AISI 1080, 1095), all of which are commercially available from a number of sources.

When used, metals, alloys, and non-metals can comprise any amount of the powder composition. The amount and type of non-TiC component can be determined by one of skill in the art for each application. As a general matter, the non-TiC portion of the powder composition preferably comprises at least 50 wt %, 60 wt %, or 65 wt % of the powder composition, and/or up to 95 wt %, 85 wt %, or 75 wt % of the powder composition.

The alloy powder can have any particle size distribution that permits combining with the TiC powder and application of the overlay. For ease of processing and handling, it is generally preferred that the alloy powder has the same particle size distribution as the TiC powder. For example, as with the TiC powder, a suitable particle size distribution for the alloy powder includes −60+325, more preferably −80+270, yet more preferably −100+230 mesh sizes.

When titanium carbide particles are cladded, they are preferably cladded with a metal or an alloy. As is well understood in the art, “cladding” refers to application of a material (e.g., metal or alloy) to the surface of another material (e.g., a TiC particle) to form a layer. “Cladding” may also refer to the material to be applied, or to the applied layer. Any metal or alloy may be used for cladding, preferably a metal or alloy that produces a suitable overlay when the composition is applied to a substrate, preferably an overlay having homogeneously distributed TiC. Preferred cladding materials include nickel and nickel alloys.

When cladded TiC particles are used, the TiC particles can be cladded by any method, and can be determined by a person of ordinary skill in the art. One such method employs a Sherritt hydrometallurgical process. When TiC particles are cladded with an alloy, the cladding can be applied directly as an alloy, or the alloy cladding can be applied in stages, e.g., application of a first metal cladding (e.g., nickel), followed by alloying the first metal cladding with another material, such as chromium and/or aluminum. The alloying process can be done by any method, such as a pack cementation method. Pack cementation comprises blending a coarse cladded powder with a fine powder of an alloying metal, and heat treating the blend in a reducing atmosphere, usually above 900° C., until the alloying element diffuses into cladding material and becomes homogenously distributed. It is also common to add an activator, such as a halide, preferably a chloride such as NH₄Cl, to increase the rate of transfer of the alloying metal into the cladding of the composite powder. Such a process is described for example in U.S. Pat. No. 3,914,507, which is incorporated herein by reference in its entirety.

### EXAMPLES

### Example 1

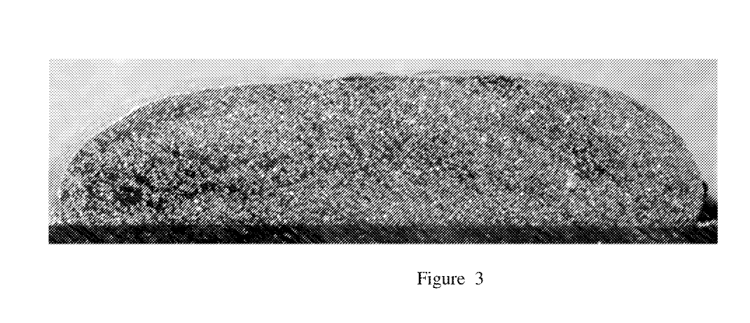

Plasma densified TiC (weight proportion round:angular about 70:30) in a particle range −125+45 micrometers (−120+325 mesh) is blended together with 65 wt % of METCOCLAD 625 powder (Oerlikon Metco) in the size range −100+200 mesh. METCOCLAD 625 powder (Oerlikon Metco) is a nickel-based powder with nominal chemistry Ni 21Cr 9Mo 4Nb. This simple mechanical mixture is PTA (Plasma Transferred Arc) deposited on a mild steel substrate. Deposition equipment is STARWELD 400A with EXCALIBUR torch and deposition parameters are: 2 l/min Ar center gas flow, 2 l/min Ar powder gas flow, 12 l/min Ar/H2 shielding gas flow, voltage 29V, current 145 A, 43 g/min feed rate, oscillation width 22 mm, dwell time on each side 0.2 s, oscillation speed 1100 mm/min, traverse speed 60 mm/min, cathode and electrode ⅛″. A cross-section of the overlay is shown in FIG. 3.

The overlay is tested according to ASTM G65 for wear resistance, and compared to tool steel D2 standard and the industry PTA standard PLASMADUR 51322 (WC+40 wt % NiCrBSi). The results are shown in Table 1.

TABLE 1

| Material | Weight loss (g) |
|---|---|
| Example 1 | 0.027 |
| D2 tool steel | 0.304 |
| PLASMADUR 51322 | 0.029 |

Two of these overlays are also tested on a corrosion-erosion tester under the following test conditions: 3.5% NaCl, 35 wt % sand loading, temperature 27° C., 24 hours. Results are shown in Table 2.

TABLE 2

| | Erosion-corrosion | Erosion |
|---|---|---|
| Material | (mg/cm²/h) | (mg/cm²/h) |
| Example 1 | 0.0166 | 0.0199 |
| PlasmaDur 51322 | 0.0414 | 0.0132 |

### Example 2

Plasma densified TiC (weight proportion round:angular about 70:30) in a particle range −125+45 micrometers (−120+325 mesh) is blended together with 70 wt % of AMDRY 805 powder (Oerlikon Metco) in the size range −140+325 mesh. AMDRY 805 powder (Oerlikon Metco) is an iron based brazing powder with the nominal chemistry Fe 29Cr 18Ni 6P 6Si 0.2RE. The simple mechanical mixture is PTA (Plasma Transferred Arc) deposited on a mild steel substrate. Deposition equipment is STARWELD 400A with EXCALIBUR torch and deposition parameters are: 2 l/min Ar center gas flow, 2 l/min Ar powder gas flow, 12 l/min Ar shielding gas flow, voltage 27V, current 120 A, 25 g/min feed rate, oscillation width 18 mm, dwell time on each side 0.2 s, oscillation speed 800 mm/min, traverse speed 50 mm/min, cathode ⅛″ and electrode 3/16″.

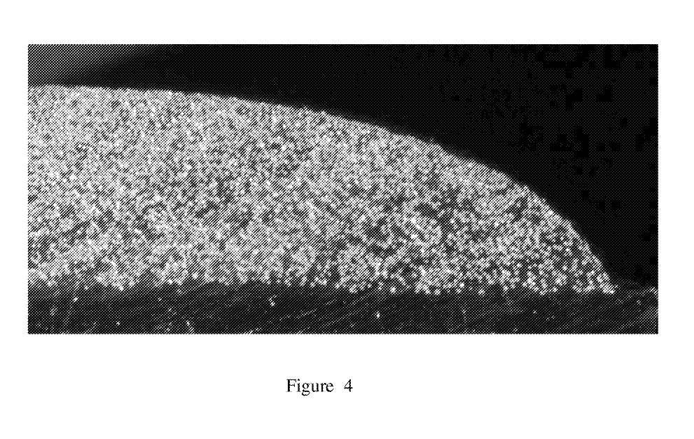

A cross-section of the overlay is shown in FIG. 4. The overlay has an even carbide distribution and good bonding.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

### Example 3

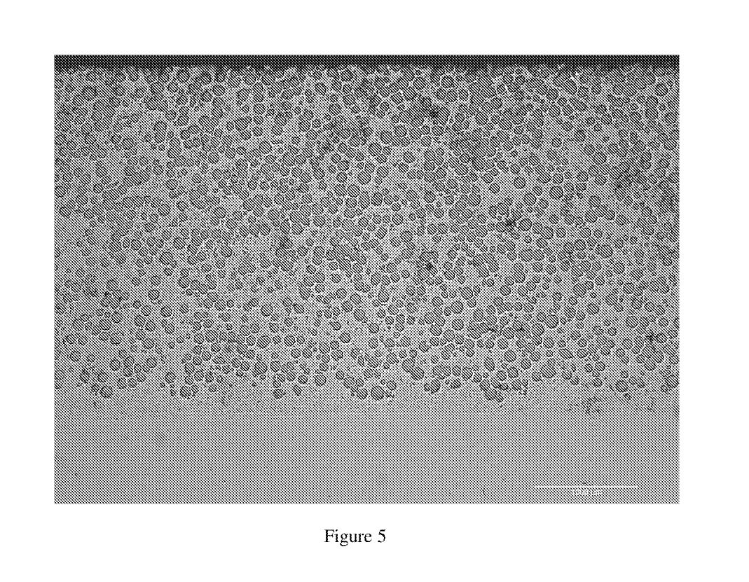

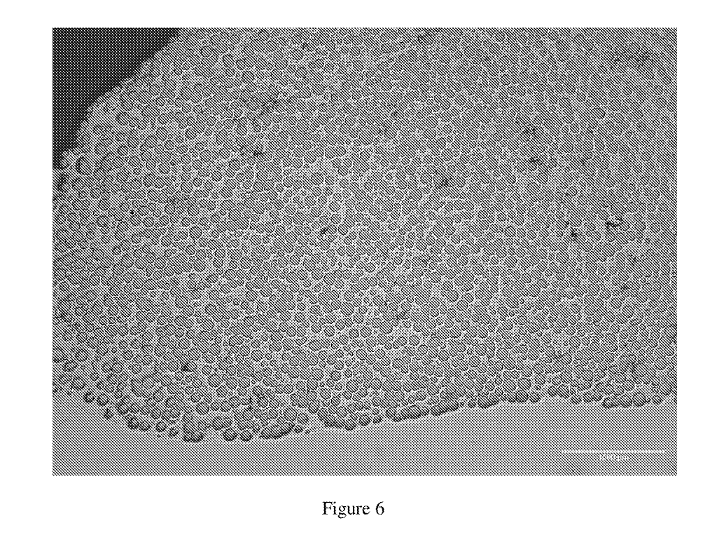

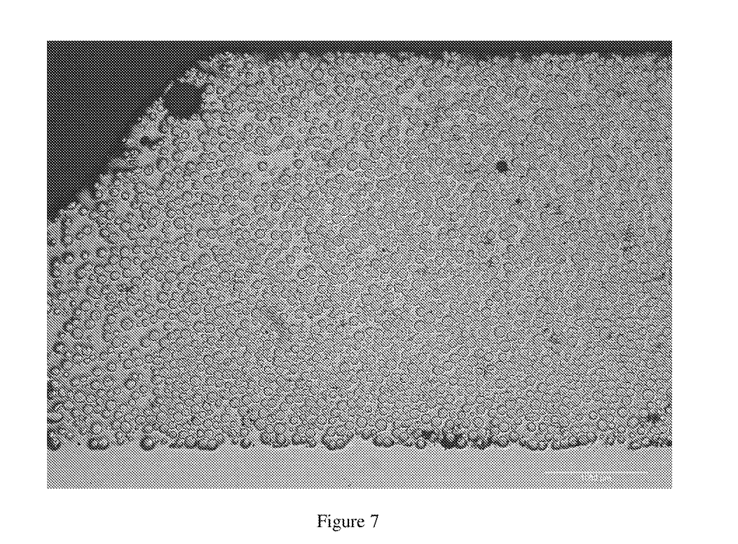

Plasma densified TiC (weight proportion round:angular about 90:10) in a particle range −150+45 micrometers (−100+325 mesh) is blended together with 65 wt % total of Metcoclad 316L-Si powder and Fe29Cr17.5Ni6.5Si6P powder alloy in the ratio 30/70, 50/50, and 70/30. Metcoclad 316L-Si powder is a stainless steel 316L based powder with an addition of Si. These blends are PTA (Plasma Transferred Arc) deposited on a mild steel substrate. Deposition equipment is STARWELD 400A with EXCALIBUR torch and deposition parameters are: 2 l/min Ar/H2 center gas flow, 2 l/min Ar powder gas flow, 16 l/min Ar shielding gas flow, voltage 30V, current 140 A, 25 g/min feed rate, oscillation width 26 mm, dwell time on each side 0.2 s, oscillation speed 1200 mm/min, traverse speed 45 mm/min, cathode 3/16″, nozzle ⅛″ for the 30/70 ratio; 3 l/min Ar/H2 center gas flow, 2 l/min Ar powder gas flow, 16 l/min Ar shielding gas flow, voltage 30V, current 140 A, 39 g/min feed rate, oscillation width 26 mm, dwell time on each side 0.2 s, oscillation speed 1000 mm/min, traverse speed 50 mm/min, cathode 3/16″, nozzle ⅛″ for the 50/50 ratio; and 3 l/min Ar/H2 center gas flow, 2 l/min Ar powder gas flow, 16 l/min Ar shielding gas flow, voltage 30V, current 120 A, 40 g/min feed rate, oscillation width 26 mm, dwell time on each side 0.2 s, oscillation speed 1000 mm/min, traverse speed 50 mm/min, cathode 3/16″, nozzle ⅛″ for the 70/30 ratio. Cross-sections of the overlays are shown in FIG. 5, FIG. 6, and FIG. 7 for ratios 30/70, 50/50, and 70/30, respectively.

The overlays are tested according to ASTM G65 for wear resistance, and compared to the industry standard Plasmadur 51322 (WC+40 wt % NiCrBSi). The results are shown in Table 3.

TABLE 3

| Material | MC316L/Fe29Cr17.5Ni6.5Si6P | Weight loss (g) |
|---|---|---|
| Example 3 | 30/70 | 0.0547 |
| Example 3 | 50/50 | 0.0506 |
| Example 3 | 70/30 | 0.0444 |
| Plasmadur 51322 | N/A | 0.0217 |

The overlays are also tested to measure characteristics such as hardness, microhardness, and Cr content in matrix. The results are shown in Table 4.

TABLE 4

| | | | | Average Cr | Average Cr |
|---|---|---|---|---|---|
| | | | Micro | content in | content in |
| | | Hardness | hardness | powder | overlay matrix |
| Material | MC316L/Fe29Cr17.5Ni6.5Si6P | HRC | HV0.1 | matrix | [wt %] |
| Example 3 | 30/70 | 52.3 | 390 | 25 | 19.3 |
| Example 3 | 50/50 | 48.3 | 387 | 23 | 15.3 |
| Example 3 | 70/30 | 42.3 | 376 | 21 | 14.4 |
| Plasmadur 51322 | N/A | 58.4 | 496 | 7 | 4 |

The overlays are also tested on a corrosion-erosion tester under the following test conditions: 3.5% NaCl, 35 wt % sand loading, temperature 27° C., 24 hours. Results are shown in Table 5.

TABLE 5

| | | Erosion- | |
|---|---|---|---|
| | | corrosion | Erosion |
| Material | MC316L/Fe29Cr17.5Ni6.5Si6P | (mg/cm²/h) | (mg/cm²/h) |
| Example 3 | 30/70 | 0.0110 | 0.0055 |
| Example 3 | 50/50 | 0.0150 | 0.0049 |
| Example 3 | 70/30 | 0.0251 | 0.0085 |
| Plasmadur | N/A | 0.0378 | 0.0077 |
| 51322 | | | |

### Example 4

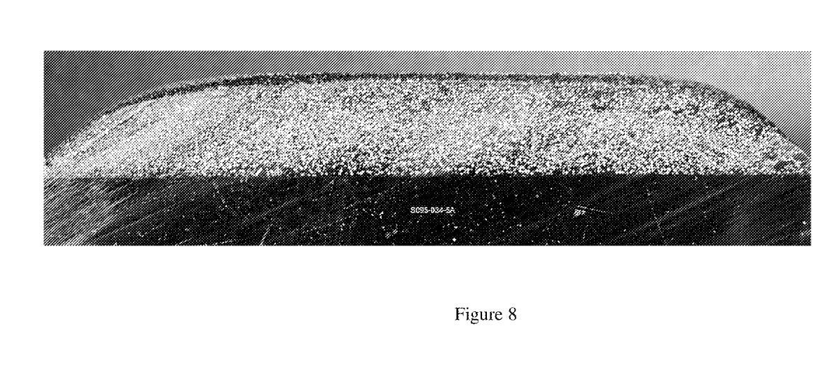

Plasma densified TiC (weight proportion round:angular about 80:20) in a particle range −150+45 micrometers (−100+325 mesh) is suspended in an autoclave and a layer of nickel cladding essentially covering the TiC particle surface is deposited using a Sherritt hydrometallurgical process known to those skilled in the art. Ni cladding comprises 65 wt % of composition. This composite powder is PTA (Plasma Transferred Arc) deposited on a mild steel substrate. Deposition equipment is STARWELD 400A with EXCALIBUR torch and deposition parameters are: 2.5 l/min Ar/H2 center gas flow, 2 l/min Ar powder gas flow, 14 l/min Ar shielding gas flow, current 120 A, 23.5 g/min feed rate, oscillation width 26 mm, dwell time on each side 0.1 s, oscillation speed 800 mm/min, traverse speed 30 mm/min, cathode 3/16″, nozzle ⅛″. A cross-section of the overlay is shown in FIG. 8.

### Example 5

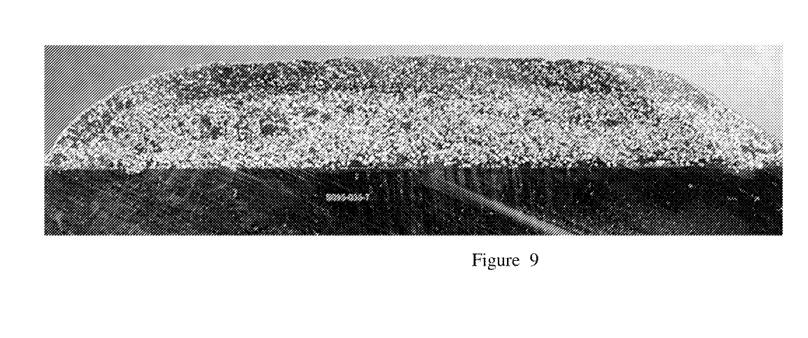

Ni clad TiC powder (e.g., from Example 4) is alloyed with Cr by pack cementation to obtain NiCr cladding with Ni/Cr ratio 80/20 wt %. This alloyed composite powder is PTA (Plasma Transferred Arc) deposited on a mild steel substrate. Deposition equipment is STARWELD 400A with EXCALIBUR torch and deposition parameters are: 2.5 l/min Ar center gas flow, 2 l/min Ar powder gas flow, 16 l/min Ar shielding gas flow, current 100 A, voltage 35V, 23.5 g/min feed rate, oscillation width 26 mm, dwell time on each side 0.1 s, oscillation speed 800 mm/min, traverse speed 30 mm/min, cathode 3/16″, nozzle ⅛″. A cross-section of the overlay is shown in FIG. 9.

### Example 6

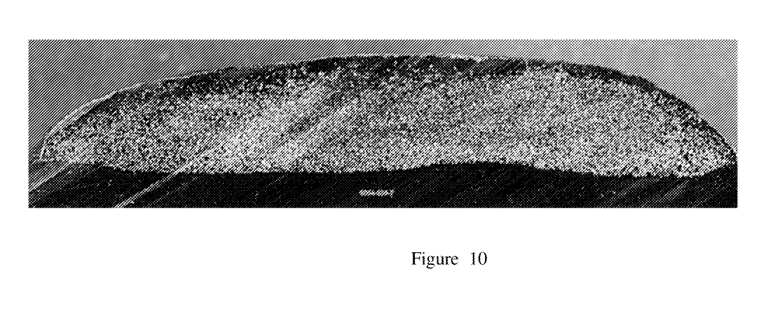

NiCr clad TiC powder (e.g., from Example 5) is further alloyed with Al by pack cementation to obtain NiCrAl cladding with Ni/Cr/Al ratio 73.5/17.8/8.7 wt %. This alloyed composite powder is PTA (Plasma Transferred Arc) deposited on a mild steel substrate. Deposition equipment is STARWELD 400A with EXCALIBUR torch and deposition parameters are: 1.5 l/min Ar center gas flow, 2 l/min Ar powder gas flow, 12 l/min Ar shielding gas flow, current 150 A, voltage 30V, 25 g/min feed rate, oscillation width 26 mm, dwell time on each side 0.1 s, oscillation speed 800 mm/min, traverse speed 30 mm/min, cathode 3/16″, nozzle ⅛″. A cross-section of the overlay is shown in FIG. 10.

The foregoing examples are provided merely for explanation, and are not to be construed as limiting the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims, as presently stated and as amended.

What is claimed:

1. A method of preparing an overlay on a substrate, the overlay comprising titanium carbide, the method comprising:
(a) obtaining a composition comprising TiC particles and non-TiC particles; and
(b) applying the composition to a substrate by plasma transferred arc welding or spray/fuse deposition to form an overlay;
wherein the TiC particles are −60+325 mesh size; wherein the titanium carbide particles comprise 50-100% by weight rounded particles, and 0-50% by weight angular particles, based on weight of TiC; and wherein the TiC comprises 5-70 wt % of the composition, based on weight of TiC and non-TiC particles; wherein the non-TiC particles comprise an alloy and/or a nonmetal.

2. The method of claim 1, wherein the composition comprises plasma-densified TiC particles.

3. The method of claim 1, wherein the composition is of −60+325 mesh size.

4. The method of claim 1, wherein the composition is of −100+230 mesh size.

5. The method of claim 1, wherein the non-TiC particles comprise an alloy comprising nickel or iron.

6. The method of claim 1, where the non-TiC particles comprise a non-metal.

7. The method of claim 1, wherein the applying comprises plasma transferred arc welding.

8. The method claim 1, wherein the overlay comprises homogeneously distributed TiC.

9. A composition suitable for plasma transferred arc welding or spray/fuse deposition, the composition comprising TiC particles and non-TiC particles, wherein the TiC particles are −60+325 mesh size; wherein the titanium carbide particles comprise 50-100% by weight rounded particles, and 0-50% by weight angular particles, based on weight of TiC; and wherein the TiC comprises 5-70 wt % of the composition, based on weight of TiC and non-TiC particles; wherein the non-TiC particles comprise an alloy and/or a nonmetal.

10. An overlay comprising titanium carbide particles, wherein the overlay is prepared by
(a) obtaining a composition comprising TiC particles and non-TiC particles; and
(b) applying the composition to a substrate by plasma transferred arc welding or spray/fuse deposition to form an overlay;
wherein the TiC particles are −60+325 mesh size; wherein the titanium carbide particles comprise 50-100% by weight rounded particles, and 0-50% by weight angular particles, based on weight of TiC; and wherein the TiC comprises 5-70 wt % of the composition, based on weight of TiC and non-TiC particles; wherein the non-TiC particles comprise an alloy and/or a nonmetal.

11. An overlay comprising titanium carbide particles, wherein the overlay is prepared by applying a composition comprising TiC particles to a substrate by plasma transferred arc welding or spray/fuse deposition to form the overlay on the substrate, wherein the overlay comprises TiC particles of −60+325 mesh size, wherein the TiC particles are homogeneously distributed in the overlay.

12. The overlay of claim 11, wherein the titanium carbide particles in the composition comprise 50-100% by weight rounded particles, and 0-50% by weight angular particles, based on weight of TiC.

13. A composition suitable for plasma transferred arc welding or spray/fuse deposition, the composition comprising clad TiC particles, wherein the clad TiC particles are −60+325 mesh size; wherein the clad TiC particles comprise titanium carbide particles and a cladding material; wherein the titanium carbide particles comprise 50-100% by weight rounded particles, and 0-50% by weight angular particles, based on weight of TiC; wherein the clad TiC particles comprise 5-70 wt % TiC; and wherein the cladding material comprises a metal and/or an alloy.

14. A method of preparing an overlay on a substrate, the overlay comprising titanium carbide, the method comprising:
(a) obtaining a composition according to claim 13; and
(b) applying the composition to a substrate by plasma transferred arc welding or spray/fuse deposition to form an overlay.

15. An overlay comprising titanium carbide particles, wherein the overlay is prepared by:
(a) obtaining a composition according to claim 13; and
(b) applying the composition to a substrate by plasma transferred arc welding or spray/fuse deposition to form an overlay.

16. An overlay comprising titanium carbide particles, wherein the overlay is prepared by applying the composition of claim 13 to a substrate by plasma transferred arc welding or spray/fuse deposition to form the overlay on the substrate, wherein the overlay comprises TiC particles of −60+325 mesh size, and wherein the TiC particles are homogeneously distributed in the overlay.

17. The composition of claim 13, wherein the cladding material comprises nickel.

18. The composition of claim 13, wherein the cladding material comprises an alloy comprising nickel

19. The composition of claim 18, wherein the alloy comprising nickel further comprises at least one of chromium and aluminum.

20. The composition of claim 13, wherein the TiC particles comprise plasma-densified TiC particles.

21. The composition of claim 13, wherein the clad TiC particles are of −100+230 mesh size.
